(19) United States
(12) Patent Application Publication
(10) Pub. No.: US 2011/0280581 A1
(43) Pub. Date: Nov. 17, 2011

(54) SYSTEMS AND METHODS FOR PRODUCING HIGH-POWER LASER BEAMS

(75) Inventors: Bien Chann, Merrimack, NH (US); Steven J. Augst, Acton, MA (US); Tso Yee Fan, Belmont, MA (US); Antonio Sanchez-Rubio, Lexington, MA (US)

(73) Assignee: MASSACHUSETTS INSTITUTE OF TECHNOLOGY, Cambridge, MA (US)

(21) Appl. No.: 12/778,670

(22) Filed: May 12, 2010

(51) Int. Cl. H04J 14/08

(52) U.S. Cl. 398/98

(57) ABSTRACT

A method of operating a high-output-power fiber laser system includes: time multiplexing a plurality of pulses, each pulse having a pulse width, and each having a different wavelength from a plurality of seed oscillators onto a single fiber; setting each pulse width to a width less than the phonon lifetime; separating in time each pulse from each other pulse so as to leave a gap between adjacent pulses; setting a time between pulses each having a common wavelength to a time longer than a round-trip time of flight through a fiber amplifier of pulses having the common wavelength; and injecting the plurality of pulses from the single fiber into the fiber amplifier. Also to disclosed is a system capable of performing the method.

### FEDERALLY SPONSORED RESEARCH

This invention was made with Government support under Air Force Contract No. FA8721-05-C-0002, Program No. 221. The Government may have certain rights to this invention.

### BACKGROUND OF INVENTION

1. Field of Invention

The invention relates to the field of fiber laser systems. More particularly, the invention relates to fiber laser systems in which high power beams are produced.

2. Discussion of Related Art

Lasers having very high output power levels are desired for a wide range of applications, including military weapons, industrial cutting and welding, and free-space laser communication applications. Currently, portable fiber lasers having good beam quality and power output levels of up to 10 kW at output wavelengths of interest are available; and, portable fiber lasers having somewhat poorer beam quality with somewhat higher power levels at output wavelengths of interest are available. Should an application require a substantially greater power output level together with good beam quality, for example a beam having a high brightness, some form of beam combining is conventionally performed. Conventional beam combining systems include Wavelength Beam Combining (WBC) and Coherent Beam Combining (CBC) systems.

### SUMMARY OF INVENTION

According to aspects of an embodiment, a method of operating a high-output-power fiber laser system includes: time multiplexing a plurality of pulses, each pulse having a pulse width, and each having a different wavelength from a plurality of seed oscillators onto a single fiber; setting each pulse width to a width less than the phonon lifetime; separating in time each pulse from each other pulse so as to leave a gap between adjacent pulses; setting a time between pulses each having a common wavelength to a time longer than a round-trip time of flight through a fiber amplifier of pulses having the common wavelength; and injecting the plurality of pulses from the single fiber into the fiber amplifier. The method may be performed in a plurality of single fibers and a corresponding plurality of fiber amplifiers, each fiber amplifier having an output, and the method may further comprise: combining the output of each fiber amplifier into a single, combined beam. According to further variations, combining further comprises: coherent beam to combining or wavelength beam combining. According to yet another variation, the method further comprises: detecting phase errors in the single, combined beam; resolving the detected phase errors into corrections applicable to one or more of the single fibers; and correcting phase differences between each of the plurality of single fibers by applying the corrections. According to yet further variations, the method further comprises: detecting phase errors in the single, combined beam; resolving the detected phase errors into corrections applicable to one or more of the single fibers; and correcting phase differences between each of the plurality of single fibers by applying the corrections.

According to aspects of another embodiment, a fiber laser system includes: a plurality (n) of seed oscillators, each seed oscillator having an output carrying plural pulses of laser light at plural different wavelengths; a plurality (n) of amplitude modulators, each amplitude modulator having an input connected to one of the plurality of seed oscillators and producing a modulated pulse train; a plurality-to-one combiner connected to receive from each amplitude modulator the modulated pulse train and combining the modulated pulse trains into a combiner output; a fiber connected to the combiner output; a one-to-plurality splitter connected to the fiber to produce a plurality (m) of splitter outputs; a plurality (m) of phase actuators, each connected to receive one of the plurality of splitter outputs; and a plurality (m) of fiber amplifiers having a phonon lifetime greater than each pulse width and having a round-trip time of flight for injected pulses less than a time between pulses having same wavelengths, producing a plurality of amplified output pulse trains, the plurality of amplified output pulse trains being sufficiently coherent as to be coherently combinable. The system, according to some variations, may further comprise: a coherent beam combining (CBC) module arranged to receive the plurality of amplified output pulse trains and having a high-power, combined output. The system may yet further comprise: a phase detector arranged to detect a phase of a pulse in the single, combined beam, and resolve the detected phase into a correction applicable to one of the plurality (m) of fibers, having an output connected to the phase actuator of the one of the plurality (m) of fibers; whereby phase differences between each of the plurality of single fibers are corrected by to applying the corrections using the phase actuator.

According to another embodiment, a fiber laser system, comprises: a plurality (n) of seed oscillators, each seed oscillator having an output carrying plural pulses of laser light at plural different wavelengths; a plurality (n) of amplitude modulators, each amplitude modulator having an input connected to one of the plurality of seed oscillators and producing a modulated pulse train; a plurality (n) of one-to-m splitters connected to receive from each amplitude modulator the modulated pulse train and each having a splitter output; a plurality (n×m) of phase actuators, each connected to receive one of the plurality of splitter outputs, and having a phase-corrected output; a plurality (m) of n-to-one combiners connected to each phase-corrected output, and each combining the modulated pulse trains into an n-to-one combiner output; a plurality (m) of fibers connected to the m n-to-one combiner outputs; and, a plurality (m) of fiber amplifiers having a phonon lifetime greater than each pulse width and having a round-trip time of flight for injected pulses less than a time between pulses having same wavelengths, producing a plurality of amplified output pulse trains, the plurality of amplified output pulse trains being sufficiently coherent as to be coherently combinable. According to some variations, the system may further comprise: a coherent beam combining (CBC) module arranged to receive the plurality of amplified output pulse trains and having a high-power, combined output. According to other variations, the system may yet further comprise: a one-to-n wavelength de-multiplexer; and, a plurality (n) of phase detectors arranged to detect phases of pulses at the plurality (n) of wavelengths in the single, combined beam, and resolve the detected phases into corrections applicable to each of the plurality (n×m) of fibers, each of the plurality of phase detectors having an output connected to one of the plurality of phase actuators of one of the plurality (n×m) of fibers; whereby phase differences between each of the plurality of single fibers are corrected by applying the corrections using the phase actuator.

### BRIEF DESCRIPTION OF DRAWINGS

The accompanying drawings are not intended to be drawn to scale. In the to drawings, each identical or nearly identical component that is illustrated in various figures is represented by a like numeral. For purposes of clarity, not every component may be labeled in every drawing. In the drawings:

FIG. 1 is a basic block diagram of wavelength beam combining;

FIG. 2 is a concept diagram illustrating beam combining concepts according to aspects of embodiments of the invention;

FIG. 3A is a block diagram of a coherent beam combining system according to aspects of embodiments of the invention;

FIG. 3B is a block diagram of another coherent beam combining system according to aspects of embodiments of the invention;

FIG. 4 schematically illustrates five notional approaches to coherent beam combining;

FIG. 5 is a schematic of a coherent beam combiner including active feedback to control pulse phase;

FIG. 6 is a schematic of one approach to a serial wavelength beam combiner;

FIG. 7 is a schematic of one approach to a parallel wavelength beam combiner;

FIG. 8 is a schematic of a wavelength beam combiner; and

FIG. 9 is a schematic of another wavelength beam combiner.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Increasing fiber laser system output power and brightness through beam combining has recently attracted much interest. Fiber lasers and amplifiers are known to have high efficiency, e.g., >80% optical-to-optical energy conversion efficiency, and >25% energy conversion efficiency from power input to optical output; produce a good beam quality based on measures such as the beam quality factor M², defined as the beam parameter product divided by λ/π, the latter being the beam parameter product for a diffraction-limited Gaussian beam with the same wavelength; and employ constructions that lend themselves to flexible packaging. Current beam combining methods include Coherent Beam Combining (CBC), one-dimensional Wavelength Beam Combining (1D WBC), two-dimensional Wavelength Beam Combining (2D WBC), and CBC/WBC Hybrid Beam Combining (HBC). One parameter of components of these systems that helps define performance and the capability of performing beam combining is bandwidth, referred to in optical systems as spectral line-width, or simply line-width. Conventional implementations of these methods currently require fiber amplifiers having a narrow line-width, meaning a line-width less than about 1-10 GHz.

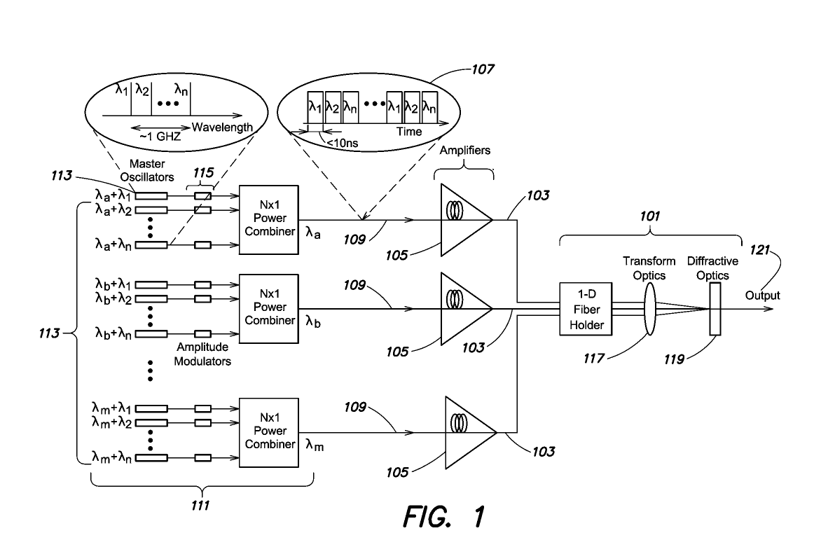

A basic block diagram of a fiber laser system using wavelength beam combining is shown in FIG. 1. The system includes combining elements 101 which receive amplified beams from plural source paths 103. Each source path includes a fiber amplifier 105, fed by a seed signal 107 carried in a fiber 109, each seed signal 107 produced by a seed module 111 including at least a seed oscillator 113.

WBC fiber laser systems, including both 1D WBC and 2D WBC, do not impose the matching requirement discussed below in connection with CBC fiber laser systems; however, there is an inversely proportional relationship between the spectral line-width and the number of amplifiers whose outputs can ultimately be combined. Thus, beam combining is incompatible with broad spectral line-width fiber amplifiers, whose use is desired to suppress stimulated Brillouin scattering (SBS) and other non-linearities in optical fiber.

CBC involves, among other things, generating two or more coherent beams, which are then amplified using fiber amplifiers, and then combining the amplified to beams to form a single, high-power beam. In order to successfully perform the coherent combining at the end of the process, coherency must be maintained at the amplifier output to within a very narrow tolerance. In a system having plural amplifiers, a relationship exists between spectral line-widths of the fiber amplifiers, the optical path length of the fiber amplifiers, and the resulting coherency between the amplifiers. This relationship requires that the absolute optical path lengths of all the amplifiers be matched to within the coherence length. Coherence length is defined as c/line-width, where c is the speed of light. So, for a line-width of 10 GHz, the coherence length is about 3×10⁸/10×10⁹ m, which is 3 cm. According to another example, this one corresponding to the conventional 10 kW systems mentioned in the background, for 10 nm spectral line-width fiber amplifiers (corresponding to about 3 THz, which is in the range of useful line-width for practical applications), the optical path length difference between all amplifiers must be less than about 0.1 mm Currently, that physical tolerance is excessively costly and/or nearly impossible to meet.

The inventive approaches disclosed and claimed, herein, both increase the power produced by a single fiber module producing a beam having a conventionally beam-combinable bandwidth, i.e. ≦1 GHz; and also increase the bandwidth of the beam-combinable fiber elements or modules to ≧10 GHz, or ≧100 GHz, or even ≧1 THz.

By employing the inventive approaches, it is now possible to extract up to 100 or more times more beam combinable output power from a single fiber than from a conventional single-frequency fiber amplifier. Thus, the total number of fiber modules used in a given beam combining system can be reduced by a factor of 100 or more, thereby reducing complexity and cost.

The power available from narrow spectral line-width fiber amplifiers, say a line-width of few kHz to a line-width of 1 GHz, is limited by non-linearities in the fiber. Much higher power can be extracted from the amplifiers if they are seeded by a broad spectrum seed source, meaning a broad spectral line-width seed source.

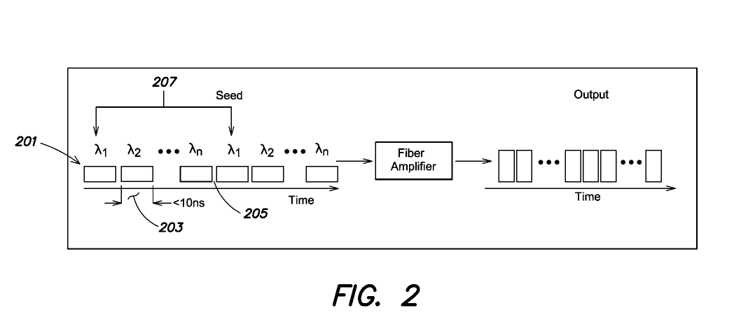

FIG. 2 illustrates a basic concept for generating high output power from a single fiber amplifier that has suitable properties for coherent beam combining to Interleaving pulse trains 201 including a sequence of pulses of different wavelengths λₓ, as now described, increases the average power operation of beam-combinable fiber amplifiers.

One aspect of embodiments involves time multiplexing plural input wavelengths λₓ. A second aspect of embodiments involves setting the pulse width 203 for each individual wavelength λₓ to be less than the phonon lifetime, meaning the lifetime of a mechanical vibration mode at audio or near-audio frequencies, in a fiber excited by the pulse at that individual wavelength. A third aspect of embodiments involves setting pulse spacing to allow a gap in time 205 with no seed excitation between adjacent excitation pulses. A fourth aspect of embodiments involves setting a repetition rate 207 between pulses of the same wavelength to be longer than the round-trip time of flight of the corresponding pulses through the fiber amplifiers.

Implementation of the concepts of FIG. 2 in the basic WBC system of FIG. 1 is now described in somewhat more detail. It includes an array of pulsed master oscillators, for example each pulsed master oscillator including a continuous wave oscillator 113 whose output is gated by an amplitude modulator 115 so as to produce a pulsed output, with each constructed and arranged to produce a unique wavelength λₓ. Other pulsed master oscillator configurations known in the art can be used. All the wavelengths λₓ are then time-multiplexed into a single, nearly continuous power waveform beam 107, as described in connection with FIG. 2, 201, above. One non-linearity, Stimulated Brillioun Scattering (SBS), is mitigated by using time bins comparable to, or shorter than, the build up time of SBS, for commonly used wavelengths namely about 10 ns, to extract high peak power. The wavelength separation between adjacent wavelengths λₓ and λₓ₊₁ is larger than the characteristic SBS spectral line-width, which is about 0.2 pm, corresponding to a frequency separation of about 50 MHz. Because of the timing gap noted above, different wavelengths λₓ do not interact with each other through SBS, four-wave mixing (FWM), or cross-phase modulation (XPM), since the timing gap prevents overlap of pulses in space within the fiber. To suppress SBS-cross-talk between pulses of the same wavelength λₓ, the forward-propagating signal and backward-propagating SBS to pulse do not overlap in the fiber amplifier, per the constraint on repetition rate noted above in connection with FIG. 2. Using the various aspects of embodiments described allows for higher average power output per fiber before the onset of non-linear effects compared with using a conventional continuous-wave seed having a wavelength that is swept from a starting wavelength to an ending wavelength over time to produce the same overall bandwidth.

In somewhat further detail, the 1D WBC system of FIG. 1 includes M fiber elements 109 each feeding one of M fiber amplifiers 105 having a spectral bandwidth Δλ≦1 GHz. The bandwidth being 1 GHz is given by way of example; other bandwidths such as 10 GHz, 100 GHz, or 1 THz, or more are possible. Each of n master oscillators 113 at a unique wavelength, λₓ, is followed by an amplitude modulator 115. The amplitude modulators 115 divide the master oscillator outputs into discrete pulses in time, surrounded by times of no signal, for purposes of time multiplexing 107. The amplitude modulators 115 produce a train of square pulses with a desired pulse repetition rate. The outputs of all amplifiers 105 are combined using transform optics 117 and diffractive optics 119 into a single output beam 121. For a 1 GHz spectral bandwidth, or similar, extraction of greater than 10 times more beam combinable power from a single fiber amplifier, as compared to 1-GHz continuous wave seed source is possible. The spectral separation between fiber elements is larger than the spectral bandwidth and is expected to be on the order of 10 to several 100 GHz. The large ratio of spectral separation to spectral bandwidth insures that there is little beam quality degradation in the output beam caused by the finite spectral bandwidth in a WBC system. Using this approach in a system with 500 fibers the total bandwidth is 50×10 GHz=5000 GHz, which is equivalent to a spectral line width of 17 nm. Assuming a cluster of 1 GHz bandwidth, with 10-GHz separation between clusters, the total bandwidth of the system is still much smaller than the gain-bandwidth of the fiber element, which is about 50 nm for Yb-doped fibers.

A similar ensemble of fiber elements can also be combined using CBC optics into a single output beam by first multiplexing the desired sequence of frequency pulses into a single beam and then power splitting the beam before amplifying and to recombining the bean into an output.

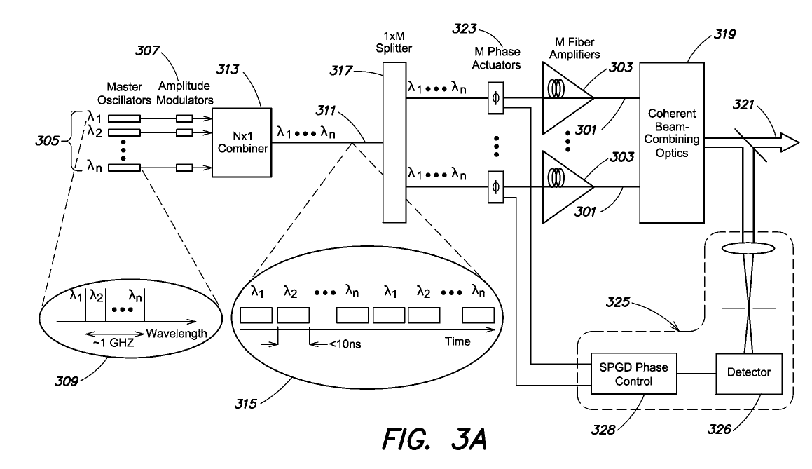

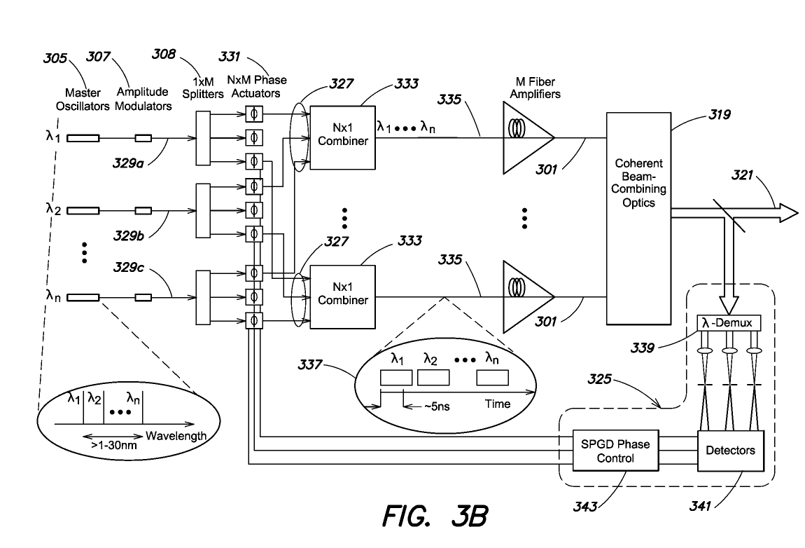

Such a system is the CBC system shown in FIG. 3A for M fiber elements 301. The total spectral bandwidth of each fiber element can be Δλ≦1 GHz, for example, or Δλ≦10 GHz or more, as desired.

The total bandwidth of the coherent beam-combinable fiber module can be increased, thereby increasing the power per fiber module, as shown in FIG. 3A, and described below. Beam combinable is taken for these examples to mean that the fiber length matching requirement is no more demanding than that of 1 GHz bandwidth, although greater or lesser bandwidth can also be considered beam combinable using the inventive concepts.

According to this aspect of an embodiment, all M fibers 301 to be combined are seeded by the same source (315, described below) formed by combining a cluster of N wavelengths (shown spectrally, 309). Each wavelength in the cluster is produced by one of the master oscillators 305 and can be taken to have around 1 kHz bandwidth or less; the seed signal 315 can include each of the N wavelengths having up to a 1 GHz combined bandwidth (shown spectrally, 309), or other beam combinable bandwidth. The cluster of N wavelengths is produced by N master oscillators 305. Amplitude modulators 307 turn each master oscillator 305 output into a pulse at different times, forming a pulse sequence. The plural pulses are combined onto a single fiber 311 by combiner 313. The seed signal 315 thus formed is then split by power splitter 317 for amplification by M fiber amplifiers 303. The amplified signals produced by amplifiers 303 are then combined by coherent beam combiner 319 to produce high-power output beam 321. The beam combinable bandwidth limitation assures the fiber length matching is not a big challenge. Phase actuators 323, one per fiber, adjust the phases of corresponding amplified wavelength clusters in each fiber of the ensemble of fibers 301 to match. Error signals to be applied to the phase actuators 323 are obtained by a suitable wave-front or far-field sensing technique 325, for example using an apertured power detector 326 and a Stochastic Parallel Gradient Descent (SPGD) phase control 328.

An alternative system is the CBC system shown in FIG. 3B, also for M fiber elements 301.

According to this aspect of an embodiment, each of the M fibers 301 to be combined are seeded by M seed signals 337, the seed signals themselves formed by combining N wavelength clusters 329a, 329b, and 329c, each cluster having up to 1 GHz bandwidth, and the total combined bandwidth of 329a, 329b, and 329c is less than the gain bandwidth of the medium, e.g. 50 nm (13 THz) for the case of Yb-doped fiber. The wavelength separation between wavelength clusters 329a, 329b, and 329c, should be such that each seed signal 337 can be easily wavelength de-multiplexed.

The N wavelength clusters 329a, 329b, and 329c, are formed by corresponding master oscillators 305 feeding amplitude modulators 307 that form the master oscillator outputs into time multiplexed pulses, each pulse being one of the N wavelength clusters 329a, 329b, and 329c. The N wavelength clusters 329a, 329b, and 329c, are each then split by splitters 308 into M signals corresponding to the M fiber amplifiers 303. The resulting N×M signals are each injected into a corresponding phase actuator 331. Phase actuators 331 equalize phases of the input wavelength clusters, as part of a feedback loop described below. An example with this approach, with 10 wavelengths up to 10 times more beam combinable output power per fiber can be extracted, over 10×30 GHz=300 GHz. The foregoing assumes a wavelength cluster of about 1 GHz bandwidth with 30 GHz separation between wavelength clusters.

Groups of the N wavelength clusters 327 are then combined onto single fibers 335 by M combiners 333, each having a single output. The seed signal 337 thus formed in each of M fibers 335 is then applied as an input to each of M fiber amplifiers 303. The resulting M amplified signals are then combined by coherent beam combiner 319 to produce high-power output beam 321. The bandwidth limitation assures the fiber length matching is not a big challenge. The N×M phase actuators 331 adjust the phases of the sources and the ensemble of fibers 301 to match at the output 321. Error signals to be applied to the phase actuators 331 are obtained by a suitable wave-front or far-field sensing technique 325, for example using wavelength de-multiplexers 339, detectors 341, and Stochastic Parallel Gradient Descent (SPGD) phase control 325.

To perform SPGD 325, a sample of the output beam is wavelength de-multiplexed by de-multiplexer 339 into its cluster components so that each wavelength cluster is separately detected by detectors 341 and then subjected to SPGD phase control 343, as shown in FIG. 3B.

The final combining performed in various aspects of embodiments may be CBC, WBC or a hybrid, as previously explained.

Many implementations of CBC have been reported and often fall into one of the following approaches notionally illustrated in FIG. 4: common resonator 401, evanescent-wave or leaky-wave coupling 403, self-organizing 405, active feedback 407, and nonlinear optical 409.

In common-resonator approaches, the array elements are placed inside an optical resonator, and feedback from the resonator is used to couple together the elements. This implementation can be viewed as being a spatially sampled version of a bulk resonator. Consequently, in analogy to a bulk resonator, the challenge for the resonator is to force lowest order transverse-mode operation. In a bulk resonator this might be done by using an intracavity spatial filter. In CBC using common resonators, mode selection has been done using intracavity spatial filters and the Talbot effect. Although these common-resonator approaches have been successful at low average power, as the power increases, typically there has been difficulty obtaining low-order transverse mode operation. One issue is variation in the optical path length, known as piston error, among the array elements particularly at higher powers, which can be viewed as being the equivalent of wavefront distortion in a bulk optical element. Piston error makes it difficult to attain lowest order transverse mode operation, in analogy to distorted optical media in bulk lasers. This common-resonator approach has been more successful with CO₂ lasers than with diode or solid-state lasers because of the much longer 10-μm wavelength of the CO₂ laser. This lower piston error (in number of waves) has enabled an 85-element CO₂ laser array to be phase-locked.

Evanescent-wave or leaky-wave coupling approaches have been used extensively, particularly in scaling to CBC semiconductor laser arrays. In this approach the array elements are placed sufficiently close together that their field to distributions overlap and thereby couple the elements. In-phase coupling of the array elements is desired to obtain high on-axis far-field intensity; however, it has been observed that the coupling often is predominantly π radius out-of-phase, giving a power null on-axis. For out-of-phase coupling, there is a null between the array elements that, compared with in-phase coupling, tends to lead either to minimum loss, particularly if the space between elements is lossy, or higher gain because the spatial overlap of the mode with the array elements is better. The other difficulty in evanescent-wave or leaky-wave approaches is scaling to large arrays.

In the self-organizing, also known as supermode, approach, the array is composed of elements with very different optical path lengths, and the optical spectrum self-adjusts to minimize the loss of the array. This approach is essentially a Michelson interferometric resonator, generalized to arrays of more than two elements. There are multiple ways of understanding this type of resonator. One is to think about the reflectivity of the resonator as a function of wavelength as seen from the output coupler. The wavelengths of the reflectivity maxima will change as the array-element path lengths vary, and if a sufficiently high reflectivity occurs at a wavelength within the gain bandwidth of the array elements, then the array will oscillate. Another way of viewing this approach is to consider each of the array elements as a separate optical resonator (from the point of view of axial-mode positions). The array elements mutually injection-lock each other at an optical frequency that is within the injection-locking range for every array element. Demonstrations have been done using this technique up to ˜10 elements using fiber lasers. However, the beam-combining efficiency appears to fall off as the number of elements increases, and prospects for scaling this implementation to large arrays are unclear. In addition, for successful implementation, there is a need to define key design parameters, such as the required differences in optical path lengths among elements.

In active-feedback implementations, path-length differences among array elements are detected, and then feedback is used to equalize the optical path lengths modulo 2π. This approach can be thought of as being equivalent to using a deformable mirror to actively correct the wavefront distortion in a bulk gain to element. This type of implementation has been used mostly in master-oscillator power-amplifier (MOPA) architectures, such as the examples described above. Some of the key issues include defining the method of detection of differences in optical path length, understanding the dynamics of variations in optical path length, and designing a servo system with an actuator with sufficient bandwidth and dynamic range that can correct for these variations.

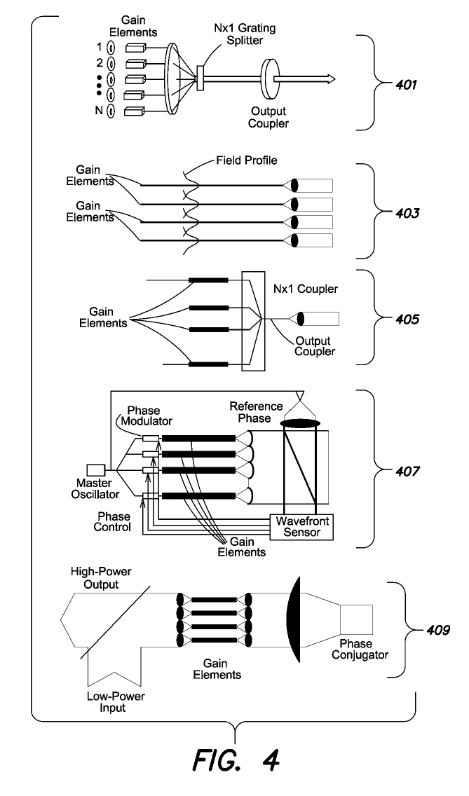

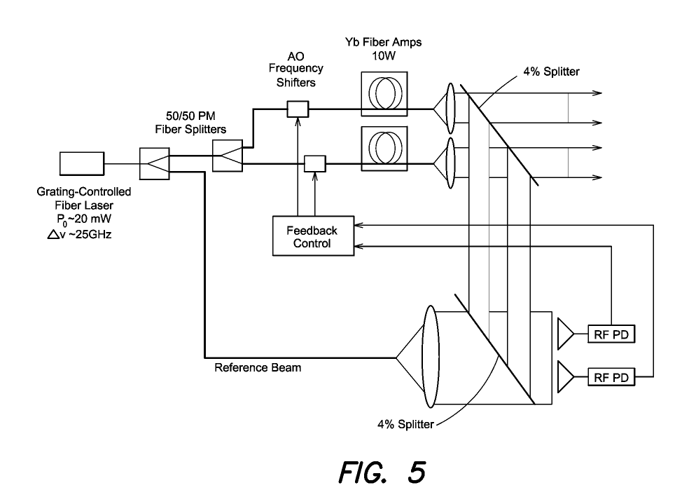

Servo loops can correct path differences in real time. For example, an array of 19 fiber-pigtailed semiconductor lasers can be injection-locked to force the array elements to operate with the same spectrum. The fiber pigtails of such a system can be brought together to a tiled aperture, and the fiber pigtail lengths can then be actively controlled to produce constructive interference in the far field. Arrays of fiber amplifiers can be phased using active feedback techniques, as illustrated in FIG. 5. In these implementations a master oscillator is input to the array of fiber amplifiers. A sample of the array output is heterodyned against a reference to extract an error signal. This error signal is fed back to a phase actuator to provide phase control.

Nonlinear optical approaches to beam combining include phase conjugation and Raman beam combining, Issues to be addressed in the design of nonlinear optical beam combining include scaling to large numbers of elements, having a low threshold, and handling the bandwidth and dynamic range of the required phase corrections.

Finally, the phase-control requirements in the context of fiber gain elements, such as used in the above examples are briefly discussed. The path-length variation, i.e., phase noise of commercial 10-W Yb-doped fiber amplifiers has been studied. At fiber amplifier turn-on, the path length changes thousands of waves, primarily driven by heating of the fiber. In thermal steady state, the path length in millisecond time scales varies a few tenths of a wave in a quiet laboratory environment, although this variation can be much larger in acoustically noisy environments. These path length changes are large enough that they must be compensated for in order to perform CBC successfully. CBC implementations must be able to accommodate these types to of fluctuations, both in terms of their bandwidth and their dynamic range. On the other hand, these fluctuations are sufficiently small that they cause negligible linewidth broadening for GHz linewidths and, thus, no compensation for these effects is anticipated to be needed in WBC systems.

Although WBC has been investigated far less than CBC for power and radiance scaling, it has been used for attaining nearly ideal combining on large laser arrays. Various implementations of wavelength combining are now discussed along with implications for element control. The requirements on element control are not really driven by fundamental requirements, in contrast to CBC, but instead are more heavily driven by implementation specifics.

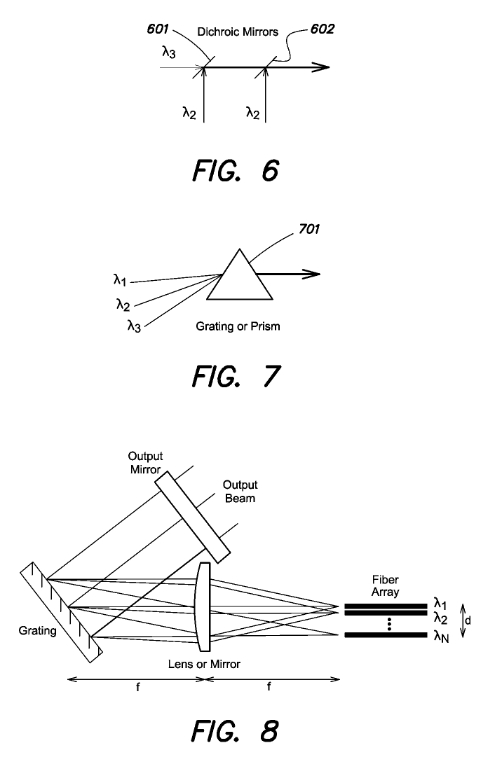

WBC implementations can be divided into two subsets, serial and parallel, characterized by the type of beam combiner employed, as shown notionally in FIGS. 6 and 7. One implementation of serial wavelength combining, shown in FIG. 6 uses dichroic interference filters 601, 602 to serially combine plural lasers operating at different wavelengths. In this implementation, each laser or channel operates at a different wavelength λₓ. The output of an individual laser is transmitted through an interference filter 601, 602 that passes its wavelength, but reflects all other wavelengths.

In a second implementation, this implementation being parallel wavelength combining, shown in FIG. 7, a single grating, a pair of gratings, called a grating rhomb (not shown), or a prism 701, can be used to wavelength-combine diode lasers operating at different wavelengths.

In an implementation for wavelength-division-multiplexing (WDM) transmitters for optical communications, also called multichannel grating cavity lasers, a one-dimensional array of semiconductor lasers is beam-combined by sharing a laser cavity that contains a grating. This method of WBC is attractive because the combination of the grating and optical feedback performs the two functions of controlling the wavelength of each individual array element and simultaneously combining the beams so that they overlap spatially. In addition, the monolithic substrate implementations have limits on power handling.

Low-loss, free-space WBC implementation that simultaneously provides wavelength control and nearly ideal beam combination for large (hundreds of elements) laser arrays is shown schematically in FIG. 8. By using optical feedback, the spectrum of each element is controlled to be different from the others and to be right for ideal beam combination. Each of the laser gain elements is inside a laser resonator, in which one resonator mirror is on one end of the gain element and at the output end of the laser resonator is the partially reflective output coupler. At the interface between the laser gain elements and free space, there is an antireflection coating or an angled facet to prevent reflections at this interface. The transform lens, grating, and output coupler are common optical elements of the external resonator shared by each of the laser array elements. The transform lens acts to transform the position of an array element into an angle of incidence on the grating, provided that the lens is located one focal length from the array. Spatial overlap of the beams from each element is ensured by placing the grating one focal length away from the transform lens. Codirectional propagation of the individual beams is forced by the flat output coupler, because the directions of propagation of the output beams are all normal to this mirror. Because the incidence angles on the grating for the beams from each array element differ, the external resonator selects different wavelengths for each array element as needed to force coaxial propagation.

Another way to view the operating principle of this external-cavity laser is to consider a single array element. A single array element can be tuned in this resonator by translating the array element in the plane of the page and perpendicular to the optical axis of the lens. When this array element is translated, the propagation direction of the output does not change because the output coupler forces propagation normal to its surface; neither does the position of the beam footprint on the grating change because it is located a focal length away from the transform lens. Consequently, if instead additional array elements are placed along this path, then each array element will operate at a different wavelength with beams that are coaxial with each other. Yet another way of viewing the operation of this architecture is via analogy to a grating spectrometer. In a grating spectrometer, typically broadband radiation is incident on the grating (propagating in a direction opposite to the combined laser output beam). The grating disperses wavelength into diffraction angle off the grating, and then a transform lens or mirror converts the propagation angle into position at the focal plane, such that different wavelengths fall onto different locations. Essentially, the spectrally combined array can be viewed as a grating spectrometer run in reverse. This implementation works with one-dimensional arrays. In principle, spectral combining can be extended to two-dimensional arrays by using crossed gratings, as is done in spectrometer systems that use CCD imagers as detectors.

Hundreds to thousands of elements can be combined under reasonable assumptions. It can be shown that the dimensional extent of the gain element array d is related to the focal length of the transform lens f, the total wavelength spread of the optical output Δλ, and the dispersion of the grating dβ/dλ, by the expression

d=f(dβ/dλ)Δλ.

The dispersion of the grating relates the change in diffraction angle to the change in optical wavelength. This dispersion, in turn, is related to the grating groove spacing a and the diffraction angle β by

dβ/dλ=1/(a cos β).

A typical value for dispersion for a 2000 lines/mm grating at 1-μm wavelength is around 4 rad/μm. For f=20 cm and a total wavelength spread of 25 nm across the array, which is achievable in fiber and semiconductor gain media near 1-μm wavelength, then d is around 2 cm, assuming 4 μm/rad grating dispersion. For array elements spaced on 250-μm centers, such a design accommodates around 80 gain elements. Tighter element spacing or larger focal length should enable even larger arrays to be combined.

This external-cavity implementation has been used to wavelength-combine diode and fiber laser arrays An array of 100 slab-coupled optical waveguide diode lasers can be beam combined with an output beam quality of M²˜1.3 and 35-W output power. In fiber laser beam combining, both oscillator and master-oscillator power-amplifier (MOPA) architectures can be used. MOPA architectures separate temporal and spectral waveform control from power generation, as it is often observed that fiber laser oscillators pulse and have undesirable spectral broadening effects. Using a MOPA architecture, an array of five 2-W Yb-doped fiber amplifiers was combined with a beam quality of M²=1.14, showing that essentially ideal WBC can be achieved with fiber arrays. Using oscillator architectures, an array of four Tm-doped fiber lasers with 11-W output power and an unspecified beam quality can be used, and an array of three Yb-doped fiber lasers with 104 W and M²=2.7 can alternatively be used with a fused-silica transmission grating for the dispersive element.

Series and parallel WBC implementations pose challenges in spectrum control and element alignment for scaling to large arrays.

In serial approaches the spectrum-control problem applies to both array elements and filters. As N increases and the wavelength spacing between elements decreases, manufacturing efficient filters becomes increasingly difficult. Second, the series arrangement requires that the angular positioning of the interference filters has tight tolerances because the laser at the end of the array accumulates a large number of bounces. Errors in angular positioning lead to smearing of the output in the far field and degradation of the on-axis intensity. The near and far fields need to overlap to a small fraction of a diffraction-limited beam to achieve a combined beam with near-diffraction-limited output. However, this basic approach of serial combination is used in WDM of transmitters for fiber-optic communication, which was enabled by developments in distributed feedback lasers, fiber Bragg gratings, and single-mode optical fibers. Efficiency is less important in the WDM transmitter application than in power and radiance scaling applications, so losses are more tolerable. The errors in angular positioning and near-field positioning are eliminated by the use of single-mode optical components, at the expense of optical loss if fiber couplers or splices are less than ideal.

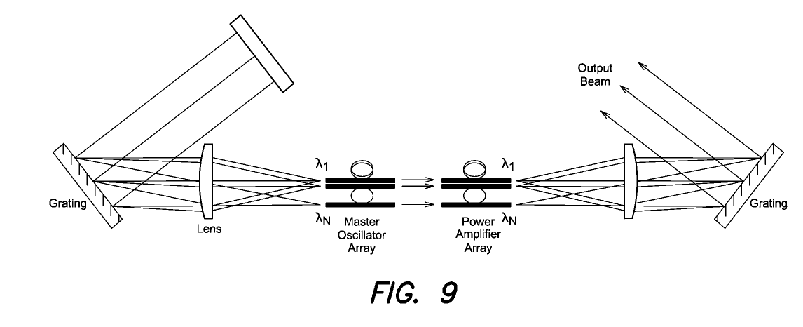

In the parallel implementations, the need for diffraction-limited alignment implies that the far-field pointing of the elements and the optical system must be arranged such that the beams have good spatial overlap on the grating. If the transform optic is exactly a focal length from the array, this means that the far-field pointing of the array elements must be the same to within a small fraction of the far-field beam divergence of a single element. In the implementations of such systems to as those in FIG. 9, there is a requirement on the element spectrum that is coupled to the near-field placement. The spectrum must be sufficiently narrow that diffraction by the grating of a finite-spectral-width beam adds far-field beam divergence that is small relative to the diffraction-limited beam divergence. The placement of an array element in the near field must be controlled to be correct, given the wavelength of the element, or conversely the wavelength of the element must be controlled to be correct, given the near-field placement of the element. The use of optical feedback automatically controls array elements to operate at a wavelength and spectral extent set by the near-field placement in the array plane. Effectively, this lifts the requirement on near-field placement in this plane, or equivalently, feedback control is being used to adjust the wavelengths to match the near-field position. Placement in the orthogonal direction (out of the plane of the array) is important; smile defects in a linear array will lead to degradation in the beam quality in the noncombining plane.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of operating a high-output-power fiber laser system, comprising:
time multiplexing a plurality of pulses, each pulse having a pulse width, and each having a different wavelength from a plurality of seed oscillators onto a single fiber;
setting each pulse width to a width less than the phonon lifetime;
separating in time each pulse from each other pulse so as to leave a gap between adjacent pulses;
setting a time between pulses each having a common wavelength to a time longer than a round-trip time of flight through a fiber amplifier of pulses having the common wavelength; and
injecting the plurality of pulses from the single fiber into the fiber amplifier.

2. The method of claim 1, performed in a plurality of single fibers and a corresponding plurality of fiber amplifiers, each fiber amplifier having an output, further comprising:
combining the output of each fiber amplifier into a single, combined beam.

3. The method of claim 2, wherein combining further comprises: coherent beam combining.

4. The method of claim 3, wherein combining further comprises: wavelength beam combining.

5. The method of claim 2, wherein combining further comprises: wavelength beam combining.

6. The method of claim 2, further comprising:
detecting phase errors in the single, combined beam;
resolving the detected phase errors into corrections applicable to one or more of the single fibers; and
correcting phase differences between each of the plurality of single fibers by applying the corrections.

7. The method of claim 3, further comprising:
detecting phase errors in the single, combined beam;
resolving the detected phase errors into corrections applicable to one or more of the single fibers; and
correcting phase differences between each of the plurality of single fibers by applying the corrections.

8. A fiber laser system, comprising:
a plurality (n) of seed oscillators, each seed oscillator having an output carrying plural pulses of laser light at plural different wavelengths;
a plurality (n) of amplitude modulators, each amplitude modulator having an input connected to one of the plurality of seed oscillators and producing a modulated pulse train;
a plurality-to-one combiner connected to receive from each amplitude modulator the modulated pulse train and combining the modulated pulse trains into a combiner output;
a fiber connected to the combiner output;
a one-to-m splitter connected to the fiber to produce a plurality (m) of splitter outputs;
a plurality (m) of phase actuators, each connected to receive one of the plurality of splitter outputs; and
a plurality (m) of fiber amplifiers having a phonon lifetime greater than each pulse width and having a round-trip time of flight for injected pulses less than a time between pulses having same wavelengths, producing a plurality of amplified output pulse trains, the plurality of amplified output pulse trains being sufficiently coherent as to be coherently combinable.

9. The system of claim 8, further comprising:
a coherent beam combining (CBC) module arranged to receive the plurality of amplified output pulse trains and having a high-power, combined output.

10. The system of claim 9, further comprising:
a phase detector arranged to detect a phase of a pulse in the single, combined beam, and resolve the detected phase into a correction applicable to one of the plurality (m) of fibers, having an output connected to the phase actuator of the one of the plurality (m) of fibers; whereby
phase differences between each of the plurality of single fibers are corrected by applying the corrections using the phase actuator.

11. A fiber laser system, comprising:
a plurality (n) of seed oscillators, each seed oscillator having an output carrying plural pulses of laser light at plural different wavelengths;
a plurality (n) of amplitude modulators, each amplitude modulator having an input connected to one of the plurality of seed oscillators and producing a modulated pulse train;
a plurality (n) of one-to-m splitters connected to receive from each amplitude modulator the modulated pulse train and each having a splitter output;
a plurality (n×m) of phase actuators, each connected to receive one of the plurality of splitter outputs, and having a phase-corrected output;
a plurality (m) of n-to-one combiners connected to each phase-corrected output, and each combining the modulated pulse trains into an n-to-one combiner output;
a plurality (m) of fibers connected to the m n-to-one combiner outputs; and,
a plurality (m) of fiber amplifiers having a phonon lifetime greater than each pulse width and having a round-trip time of flight for injected pulses less than a time between pulses having same wavelengths, producing a plurality of amplified output pulse trains, the plurality of amplified output pulse trains being sufficiently coherent as to be coherently combinable.

12. The system of claim 11, further comprising:
a coherent beam combining (CBC) module arranged to receive the plurality of amplified output pulse trains and having a high-power, combined output.

13. The system of claim 12, further comprising:
a one-to-n wavelength de-multiplexer; and,
a plurality (n) of phase detectors arranged to detect phases of pulses at the plurality (n) of wavelengths in the single, combined beam, and resolve the detected phases into corrections applicable to each of the plurality (n×m) of fibers, each of the plurality of phase detectors having an output connected to one of the plurality of phase actuators of one of the plurality (n×m) of fibers; whereby
phase differences between each of the plurality of single fibers are corrected by applying the corrections using the phase actuator.
